(19) United States
(12) Patent Application Publication
(10) Pub. No.: US 2004/0182226 A1
(43) Pub. Date: Sep. 23, 2004

(54) Simplified system for writing music

(76) Inventor: Kourosh Dini, Chicago, IL (US)

Correspondence Address: KOUROSH DINI, 1020 S. Wabash #4G, Chicago, IL, 60605, US

(21) Appl. No.: 10/384,921

(22) Filed: Mar. 5, 2003

(51) Int. Cl. G09B 15/00

(52) U.S. Cl. 84/483.1

(57) ABSTRACT

The present invention is a system for writing music without the use of conventional musical notation using a rectangularly ruled sheet of paper, a simplified sound designation notation, a simplified method of designating the time scheme for a group of sounds and a way to efficiently and easily designate the repetition of a group of sounds.

The present invention relates to a system for writing music and particularly to a system for writing music using rectangularly ruled paper and limited musical notation

### BACKGROUND OF THE INVENTION

The conventional system for composing music is long established. The system involves writing upon five-lined staff paper musical symbols having various meanings. Specific notation is used to define the length of a particular beat, other notation defines the proper scale upon which the composed music is to be placed, while further notation defines the proper time signature for the composition. The note to be played is communicated by its placement on the staff lines. While this system may easily communicate the general procession of the composition according to the relative position of the notes, the system is virtually unintelligible to the novice composer to whom the notes, time schemes and key signatures it takes years to learn to decipher.

Several patents have introduced methods of writing music that overcomes the troubles of the standard method. U.S. Pat. No. 3,741,066 to Cromleigh uses a three-lined staff paper to more easily correspond to the keys of a piano. The system, however, is tailored to a keyboard instrument and further requires knowledge of novel notation to indicate notes.

U.S. Pat. No. 3,698,277 to Barra attempts to ease recognition of the length of notes by employing an analog system of musical notation. In that system, bars are placed on conventional five-lined staff paper whose length corresponds to the length of the note to be played. The system, however, addresses only the specific problem of identifying the length of a note and further requires knowledge of all the other notation associated with the standard system of composing music.

U.S. Pat. No. 3,700,785 to Leonard utilizes stickers to indicate the tonal changes from one note or chord to the next. The system, however, requires a specialized board adapted to the stickers and a specific key signature predetermined to the composition.

A need exists in the art for a simplified system for writing music that overcomes the many deficiencies in the prior art.

### SUMMARY OF THE INVENTION

It is an object of the present invention to provide a simplified way of composing music without the use of staff lines. A feature of the present invention is the use of rectangularly ruled paper defining boxes and rectangles to designate the time value and length of groups of sounds. Another feature of the invention is the use of lines written in the boxes above and below a sound designating means to indicate changes of one octave or more. Another feature of the present invention is the use of a letter to represent a note or chord without relation to a space on corresponding staff lines. An advantage of the present invention is that it allows composition of complicated musical schemes with limited or no musical training. Another advantage of the invention is that it is easy to identify the note or chord to be played.

Still another object of the present invention is to provide a means for repeating a group of sounds efficiently. A feature of the present invention is the use of blank boxes and numbering schemes to designate the group of sounds to be repeated. The advantage of the present invention is in saving the time and space of having to rewrite complicated musical patterns when the same pattern has already been used in the composition.

Yet another object of the present invention is to provide a new system for writing music without the need to memorize new notation. A feature of the present invention is the use of letters to designate notes and chords. Another feature of the present invention is the use of conventional note notation or numerals to designate the time value for each box. An advantage of the present invention is its ease of learning for composers of all levels of experience.

Yet another object of the present invention is to create a system for writing music adaptable to widely available paper. A feature of the present invention is its ability to be written upon any rectangularly ruled graph paper or manually rectangularly ruled paper. An advantage of the invention is that it can be practiced without special musical paper.

In brief, the present invention is a system for writing music comprising in combination: a sheet defined by a plurality of intersecting lines, said lines defining a rectangle adapted to the length of a phrase and said rectangle defined by boxes adapted to the time value of a sound wherein said rectangles are read from top to bottom in successive columns from left right and wherein said sound is played within the same regional scale as the sound immediately preceding said sound; a means for designating said sound in said box; a means for specifying the length of said phrase; a means for specifying the time value of said sound per box; a means for designating the repetition of a group of sounds; a means for specifying a distance between adjacent sounds of one octave or more; and a means for identifying a group of sounds.

### BRIEF DESCRIPTION OF THE DRAWINGS

The invention and its objectives and advantages will be better understood from the detailed description below with the drawings in which:

FIG. 1 is a representative sample of a piece of music written with the present system.

FIG. 2 is a sample of a portion of music demonstrating a particular repetition means.

### DETAILED DESCRIPTION OF THE PREFERRED EMBODIMENT

The present system for writing music overcomes many of the defects in the prior art by permitting a novice musician to write complicated musical schemes without knowledge of conventional musical notation such as staff lines, note symbols, measures and scales.

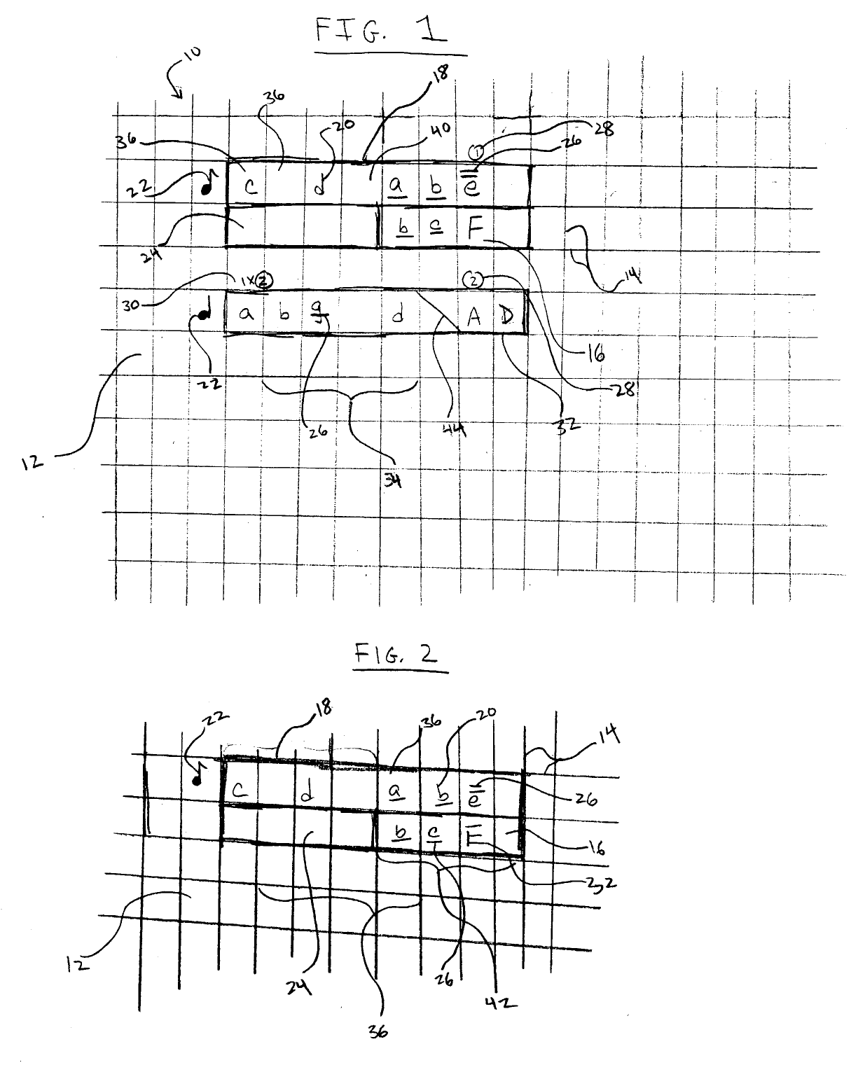

A detailed description of the preferred embodiment of the present system is provided in FIG. 1. In FIG. 1, the present system, denoted generally as numeral 10, comprises a sheet 12 defined by a plurality of perpendicular intersecting lines 14, such lines as may be found on widely available rectangularly ruled graph paper. The intersecting lines 14 may also be created manually by drawing perpendicular lines upon any ruled paper. The intersecting lines 14 upon the sheet 12 creates a plurality of rectangles 34, said rectangles further defined by boxes 16. In the preferred embodiment 10, the intersecting lines define square boxes 16 which combine to form rectangles 34. However, a suitable sheet (not shown) may comprise intersecting perpendicular lines not defining square boxes but rectangular boxes themselves.

In combination with the sheet 12 defined by boxes 16 and rectangles 34, the music writer is prepared to author a musical phrase 36, said phrase 36 being a group of notes, chords, pauses or other sounds to be played together and written on a single line, analogous in conventional music writing to a measure. A phrase requires two elements: the amount of beats per phrase and the length of the notes in the phrase. In the present invention, the length of the phrase 36 is defined by tracing out a rectangle 18 upon the sheet 12, said rectangle 18 defined by boxes 16 adapted to the length of the sound to be played therein. Said sound could be a musical note, a musical chord, multiple notes or chords, or a pause in the music. The sound designating means could be a lower case letter 20 for a note, an upper case letter 32 for a chord, or a slash 44 for a pause. The amount of beats per phrase 36 depends upon the time value designated to each box 16 contained within the rectangle 18 defining the particular phrase 36.

The present system further provides a means for designating the time value per box 22. Said time value designating means 22 is written adjacent to the rectangle 18 defining the phrase 36. Hence, the length of the phrase 36 is the time value per box, designated by a time value designating means 22, times the amount of boxes 16 contained in the rectangle 18 defining said phrase 36.

The time value designating means 22 could be a conventional musical note, such as a single eighth note written a adjacent to the rectangle 18 defining the phrase 36 to designate that each box 16 receives an eighth of a beat; or a numeral, the reciprocal of which defines the length of the sound in the box 16. Therefore, a rectangle 18 containing 8 boxes 16 with an eighth note written adjacent to said rectangle 18 defines a phrase 36 analogous to a conventional musical measure with the time scheme 8/8. A sound, such as a note 20, a chord 32, or a combination of sounds can be longer than the value of a box 16 by leaving a blank box 40 following the box 16 containing said sound designating means. For example, a note 20 written in an eight note box 16 can be played for a quarter beat by leaving a blank box 40 following said box 16 containing the note 20.

The present invention also comprises a means for repeating a group of sounds. Said group of sounds could be phrase 36, a portion of a phrase 38, or a group of phrases and portions of phrases. Said group of sounds are repeated by writing a blank box 24 below the group to be repeated. In FIG. 2, the initial phrase 36 of a fourth note “c” followed by a fourth note “d” followed by an eighth “a,” an eighth “b” and a fourth “e” has the initial portion 38 repeated by use of the blank rectangle 24 written below the portion 38 to be repeated. The new phrase 42 is completed be incorporating the sounds designated in the following boxes.

A further repetition means is accomplished using a group identification means in combination with a scheme for designating how many times said group is to be repeated. In FIG. 1, the group of phrases is designated by group identification means 28 such as a number. A repetition designating means 30 such as said number times the amount of times said group is to be repeated, is written where said repetition is to occur.

The system further comprises a means for specifying a distance between adjacent sounds of one octave or more. Said means 26 could be a small horizontal line written in the box 16 containing said sound designation means, such as a lower case letter 20 for a note or an upper case letter 32 for a chord, immediately above or below the sound designation means. The box 16 containing the distance specifying means 26 indicates that the sound designated in that box 16 is to be played on a regional scale different than the previous sound, where a regional scale consists of the note itself, the notes up to and including the six half steps above the given note, and the notes down to and including the five half steps below the given note. For example, the regional scale for the note “c” would include the “g” below it up through the “f#” above it. Hence the scale is not defined for the entire phrase 36, but only for the individual sound. A suitable use of the distance specifying means 26 is to write an amount of horizontal lines above the sound designating means, such as a lower case letter 20 for a note or an upper case letter 32 for a chord, to indicate the amount of octaves below the regional scale of the previous sound upon which the present sound is to be played. Similarly, one would use the distance specifying means 26 to write an amount of horizontal lines

What is claimed is:

1. A system for writing music comprising in combination:
a) a sheet defined by a plurality of intersecting lines, said lines defining a rectangle adapted to the length of a phrase and said rectangle defined by boxes adapted to the time value of a sound wherein said rectangles are read from top to bottom in successive columns from left right and wherein said sound is played within the same regional scale as the sound immediately preceding said sound;
b) a means for designating said sound in said box;
c) a means for specifying the length of said phrase;
d) a means for specifying the time value of said sound per box;
e) a means for designating the repetition of a group of sounds; and
f) a means for specifying a distance between adjacent sounds of one octave or more.

2. The system as recited in claim 1 wherein said distance specifying means is one or more lines below said sound designating means wherein said sound is played on the regional scale above the preceding sound corresponding to the number of lines below said sound designating means.

3. The system as recited in claim 1 wherein said distance specifying means is one or more lines above said sound designating means wherein said sound is played on the regional scale below the preceding sound corresponding to the number of lines above said sound designating means.

4. The system as recited in claim 1 wherein said sound designating means is a lower case letter defining a musical note.

5. The system as recited in claim 1 wherein said sound designating means is an upper case letter defining a musical chord.

6. The system as recited in claim 1 wherein said means for specifying the time value of said sound per box is a musical note symbol written adjacent to said rectangle containing said box.

7. The system as recited in claim 1 wherein said repetition designating means is a blank rectangle below said group of sounds to be repeated.

8. A system for writing music comprising in combination:
a) a sheet defined by a plurality of intersecting lines, said lines defining a rectangle adapted to the length of a phrase and said rectangle defined by boxes adapted to the time value of a sound wherein said rectangles are read from top to bottom in successive columns from left right and wherein said sound is played within the same regional scale as the sound immediately preceding said sound;
b) a means for designating said sound in said box;
c) a means for specifying the length of said phrase;
d) a means for specifying the time value of said sound per box;
e) a means for designating the repetition of a group of sounds;
f) a means for specifying a distance between adjacent sounds of one octave or more; and
g) a means for identifying a group of sounds.

9. The system as recited in claim 8 wherein said distance specifying means is one or more lines below said sound designating means wherein said sound is played on the regional scale above the preceding sound corresponding to the number of lines below said sound designating means.

10. The system as recited in claim 8 wherein said distance specifying means is one or more lines above said sound designating means wherein said sound is played on the regional scale below the preceding sound corresponding to the number of lines above said sound designating means.

11. The system as recited in claim 8 wherein said sound designating means is a lower case letter defining a musical note.

12. The system as recited in claim 8 wherein said sound designating means is an upper case letter defining a musical chord.

13. The system as recited in claim 8 wherein said means for specifying the time value of said sound per box is a musical note symbol written adjacent to said rectangle containing said box.

14. The system as recited in claim 8 wherein said repetition designating means is a blank rectangle below said group of sounds to be repeated.

15. The system as recited in claim 8 wherein said group identifying means is a number written above said group of sounds.

16. The system as recited in claim 15 wherein said repetition designating means is said number times an amount of times said group of sounds is to be repeated written where the repetition is to occur.

17. A system for writing music comprising in combination:
a) a sheet defined by a plurality of intersecting lines, said lines defining a rectangle adapted to the length of a phrase and said rectangle defined by boxes adapted to the time value of a sound wherein said rectangles are read from top to bottom in successive columns from left right and wherein said sound is played within the same regional scale as the sound immediately preceding said sound;
b) a lower case letter defining a musical note written in said box;
c) a musical note symbol defining a time value per box written adjacent to said box;
d) a blank rectangle below a group of sounds to be repeated;
e) a first number written above a group of sounds identifying said group; and
f) a second number written times said first number defining an amount of times said group of sounds is to be repeated.
